(19) United States
(12) Patent Application Publication
(10) Pub. No.: US 2020/0183373 A1
(43) Pub. Date: Jun. 11, 2020

(54) METHOD FOR DETECTING ANOMALIES IN CONTROLLER AREA NETWORK OF VEHICLE AND APPARATUS FOR THE SAME

(71) Applicant: Electronics and Telecommunications Research Institute, Daejeon (KR)

(72) Inventors: Joong-Yong CHOI, Sejong-si (KR); Sok-Joon LEE, Daejeon (KR); Hyeok-Chan KWON, Daejeon (KR); Byung-Ho CHUNG, Daejeon (KR)

(21) Appl. No.: 16/702,741

(22) Filed: Dec. 4, 2019

(30) Foreign Application Priority Data
Dec. 7, 2018 (KR) 10-2018-0157381

(51) Int. Cl. G05B 23/02; H04L 12/40; H04L 29/12

(52) U.S. Cl. CPC G05B 23/0243; G06N 20/00; H04L 61/6027; H04L 12/40

(57) ABSTRACT

A method for detecting anomalies in a controller area network of a vehicle and an apparatus for the same. The method for detecting anomalies in a Controller Area Network (CAN) of a vehicle includes monitoring the controller area network of the vehicle and generating sequence trees for respective multiple sub-networks included in the controller area network at a time at which monitoring is performed, comparing at least one normal sequence tree, generated in accordance with the controller area network when a status of the vehicle is normal, with the generated sequence trees, and calculating differences between traffic proportions for respective nodes based on a result of the comparison between the sequence trees, and detecting an anomaly in the vehicle in consideration of the differences.

### CROSS REFERENCE TO RELATED APPLICATION

This application claims the benefit of Korean Patent Application No. 10-2018-0157381, filed Dec. 7, 2018, which is hereby incorporated by reference in its entirety into this application.

### BACKGROUND OF THE INVENTION

### 1. Technical Field

The present invention relates generally to technology for detecting anomalies occurring in a Controller Area Network (CAN) of a vehicle, and more particularly, to technology for analyzing proportions of traffic occupied by respective nodes included in sequence trees for respective CAN IDs of a vehicle and then detecting anomalies in the CAN.

### 2. Description of Related Art

As a network used between Electronic Control Units (ECUs) mounted in a vehicle, a Controller Area Network (CAN) is generally used. In the CAN, an On-Board Diagnostics (OBD)-II port for a diagnosis function or a connector for adding an ECU is also provided. By means of this configuration, it is possible to access a CAN bus or send illegal messages from the outside of the vehicle. Various types of research into the detection of such illegal messages are being conducted, and there are general schemes for detecting and blocking the corresponding illegal messages through an authentication process.

However, in the case of CAN, a standard format is fixed, and the amount of data to be transmitted is increased when an authentication process is added, and thus the economic burden is inevitably increased. In addition, in recent research, there is proposed a scheme in which a deep-learning function is introduced to monitor a CAN bus, after which a normal network is trained to detect illegal messages. Although this scheme is praiseworthy in that it is a new attempt, it is difficult to regard the scheme as a realistic solution when the specifications and expenses of devices, including ECUs to be installed in a vehicle, are taken into consideration.

Further, since the conventional scheme determines the occurrence of anomalies using only correlations between previous and subsequent messages or using only similarities therebetween by learning the pattern of a normal network, there is a limitation in detecting a replay attack or a Denial of Service (DoS) attack which repeatedly injects a large number of message patterns.

### PRIOR ART DOCUMENTS

### Patent Documents

(Patent Document 1) Korean Patent No. 10-1371902, Date of Publication: Mar. 10, 2014 (Title: Apparatus for Detecting Vehicle Network Attack and Method thereof)

### SUMMARY OF THE INVENTION

Accordingly, the present invention has been made keeping in mind the above problems occurring in the prior art, and an object of the present invention is to detect anomalies with respect to the situation in which sequence trees for respective IDs of a CAN bus in a vehicle are changed by a reference value or more based on the results of learning.

Another object of the present invention is to provide robust detection technology that can also detect repetitive injection of pattern messages recognized as normal messages as well as message patterns newly added to a controller area network of a vehicle.

A further object of the present invention is to provide an alert, advising of an illegal attempt, to a driver or an owner of a vehicle when hacking of the vehicle is attempted or intrusion into the vehicle is attempted, thus making the driver or owner aware of the danger.

In accordance with an aspect of the present invention to accomplish the above objects, there is provided a method for detecting anomalies in a Controller Area Network (CAN) of a vehicle, including monitoring the controller area network of the vehicle and generating sequence trees for respective multiple sub-networks included in the controller area network at a time at which monitoring is performed; comparing at least one normal sequence tree, generated in accordance with the controller area network when a status of the vehicle is normal, with the generated sequence trees; and calculating differences between traffic proportions for respective nodes based on a result of the comparison between the sequence trees, and detecting an anomaly in the vehicle in consideration of the differences.

Detecting the anomaly may be configured to, when at least one of a case where a new node is present in a corresponding sequence tree and then a difference between respective nodes occurs and a case where the differences between the traffic proportions for respective nodes are greater than a threshold value is satisfied, determine that the anomaly has occurred in the vehicle.

The multiple sub-networks may be generated to correspond to sequence combinations, each having CAN IDs transmitted from multiple vehicle control units connected to the controller area network as respective nodes.

Each of the sequence combinations may include at least two nodes.

The method may further include repeatedly performing monitoring of the controller area network when the status of the vehicle is normal; and generating the normal sequence tree based on learning using a result of the repeatedly performed monitoring.

The threshold value may be set using traffic values per unit time and a standard deviation of traffic values in consideration of message-sending periods for respective sub-networks extracted based on the normal sequence tree.

The threshold value may be set such that, when each message-sending period is shorter than a preset reference period, a maximum value and a minimum value of traffic per unit time are set as an upper limit and a lower limit of the threshold value, respectively.

The threshold value may be set such that, when each message-sending period is equal to or longer than the preset reference period, an error range that is designated based on the standard deviation is set as a range of the threshold value.

In accordance with another aspect of the present invention to accomplish the above objects, there is provided an apparatus for detecting anomalies in a Controller Area Network (CAN) of a vehicle, including a processor for monitoring the controller area network of the vehicle, generating sequence trees for respective multiple sub-networks included in the controller area network at a time at which monitoring is performed, comparing at least one normal sequence tree, generated in accordance with the controller area network when a status of the vehicle is normal, with the generated sequence trees, calculating differences between traffic proportions for respective nodes based on a result of the comparison between the sequence trees, and detecting an anomaly in the vehicle in consideration of the differences; and a memory for storing the at least one normal sequence tree.

The processor may be configured to, when at least one of a case where a new node is present in a corresponding sequence tree and then a difference between respective nodes occurs and a case where the differences between the traffic proportions for respective nodes are greater than a threshold value is satisfied, determine that the anomaly has occurred in the vehicle.

The multiple sub-networks may be generated to correspond to sequence combinations, each having CAN IDs transmitted from multiple vehicle control units connected to the controller area network as respective nodes.

Each of the sequence combinations may include at least two nodes.

The processor may be configured to repeatedly perform monitoring of the controller area network when the status of the vehicle is normal and generate the normal sequence tree based on learning using a result of the repeatedly performed monitoring.

The threshold value may be set using traffic values per unit time and a standard deviation of traffic values in consideration of message-sending periods for respective sub-networks extracted based on the normal sequence tree.

The threshold value may be set such that, when each message-sending period is shorter than a preset reference period, a maximum value and a minimum value of traffic per unit time are set as an upper limit and a lower limit of the threshold value, respectively.

The threshold value may be set such that, when each message-sending period is equal to or longer than the preset reference period, an error range that is designated based on the standard deviation is set as a range of the threshold value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an operation flowchart illustrating a method for detecting anomalies in a controller area network of a vehicle according to an embodiment of the present invention;

FIG. 2 is a diagram illustrating an example of an in-vehicle communication network architecture according to the present invention;

FIG. 3 is a diagram illustrating an example of a structure in which the relationship between the control system and the vehicle gateway of FIG. 2 is simplified;

FIG. 4 is a diagram illustrating an example of an intrusion path of an in-vehicle communication network according to the present invention;

FIGS. 5 and 6 are diagrams illustrating an example of a normal sequence tree for a vehicle and traffic proportions for respective nodes according to the present invention;

FIGS. 7 and 8 are diagrams illustrating an example of a sequence tree and traffic proportions for respective nodes in an attack situation according to the present invention;

FIG. 9 is a diagram illustrating an example of a probability distribution for setting a threshold value according to the present invention;

FIG. 10 is an operation flowchart illustrating in detail a process for generating a normal sequence tree in the method for detecting anomalies in a controller area network of a vehicle according to an embodiment of the present invention;

FIG. 11 is an operation flowchart illustrating in detail a process for detecting anomalies in the method for detecting anomalies in a controller area network of a vehicle according to an embodiment of the present invention;

FIG. 12 is a block diagram illustrating an apparatus for detecting anomalies in a controller area network of a vehicle according to an embodiment of the present invention; and

FIG. 13 is a block diagram illustrating a system for detecting anomalies in a controller area network of a vehicle, included in the vehicle gateway of FIG. 2.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

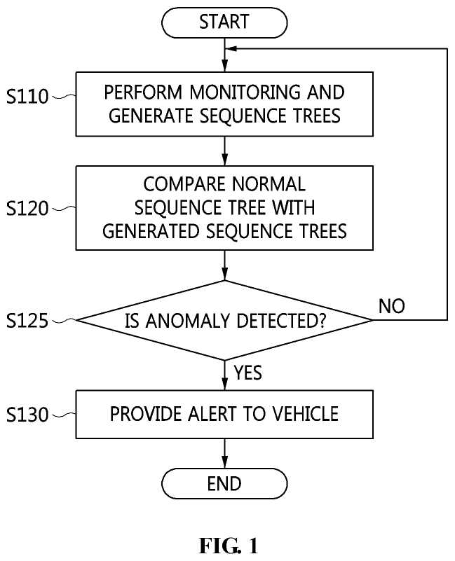

FIG. 1 is an operation flowchart illustrating a method for detecting anomalies in a vehicle control network (i.e., a controller area network of a vehicle) according to an embodiment of the present invention.

Referring to FIG. 1, the method for detecting anomalies in the controller area network of the vehicle according to the embodiment of the present invention may monitor the Controller Area Network (CAN) of the vehicle, and may generate sequence trees for respective multiple sub-networks included in the CAN at the time at which monitoring is performed at step S110.

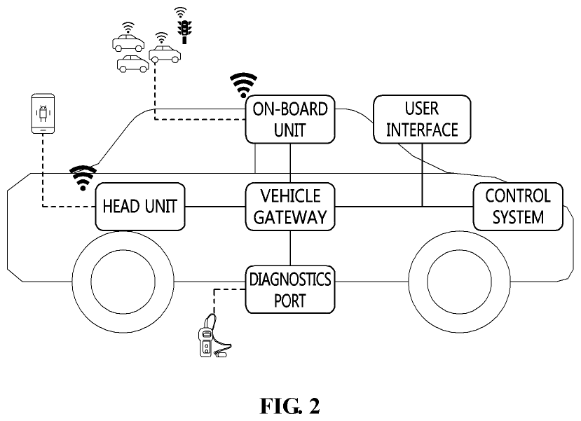

First, an in-vehicle communication network architecture according to an embodiment of the present invention may include a head unit, an on-board unit, a vehicle gateway, a diagnostics port, a user interface, and a control system, as illustrated in FIG. 2.

The head unit may correspond to an infotainment device which takes charge of Audio, Video, Navigation (AVN) functions, and may provide a function of interworking with a smart device through Wi-Fi, Bluetooth, or Universal Serial Bus (USB) connection.

The on-board unit performs Wireless Access for Vehicle Environment (WAVE) communication so as to realize inter-vehicle communication and communication between the vehicle and infrastructure. For this, research into services that use Long-Term Evolution (LTE) and fifth-generation (5G) communication through mobile carriers has been conducted.

The diagnostics port may correspond to a port used to connect an exclusive diagnosis device so as to check the status of the vehicle including the occurrence of faults or failure in the vehicle, and may be an On-Board Diagnostics (OBD-II) port.

The control system may be implemented such that various ECUs in the vehicle are grouped into a single unit, and may be composed of various sub-networks using a Controller Area Network (CAN), a CAN with Flexible Data rate (CAN-FD), a Local Interconnect Network (LIN), FlexRay, Media Oriented Systems Transport (MOST), Automotive Ethernet, or the like.

The vehicle gateway may manage information of various sub-networks in the control system, and may take charge of information delivery between various devices, such as the on-board unit and the head unit.

Also, the vehicle gateway may be a device including an anomaly detection system considered important in the present invention, and may provide alert guidance through the user interface when the corresponding detection system detects an anomaly or intrusion into the vehicle.

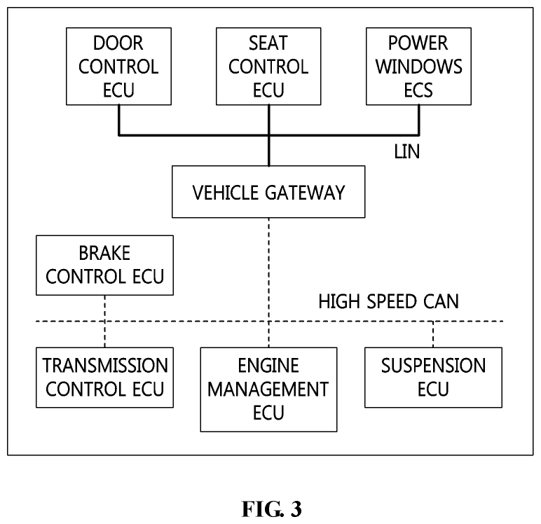

Below, the relationship between the vehicle gateway and the control system will be described in detail with reference to FIG. 3.

First, as illustrated in FIG. 3, the vehicle gateway may manage information of various sub-networks of the control system, and may include an anomaly detection system considered important in the present invention while performing its original function of performing information delivery between various devices, such as the on-board unit and the head unit. Also, the control system may be implemented by grouping 50 to 100 various ECUs, such as a brake control ECU, a transmission control ECU, an engine management ECU, a suspension ECU, a door control ECU, a seat control ECU, and a power windows ECU, per vehicle into a single system.

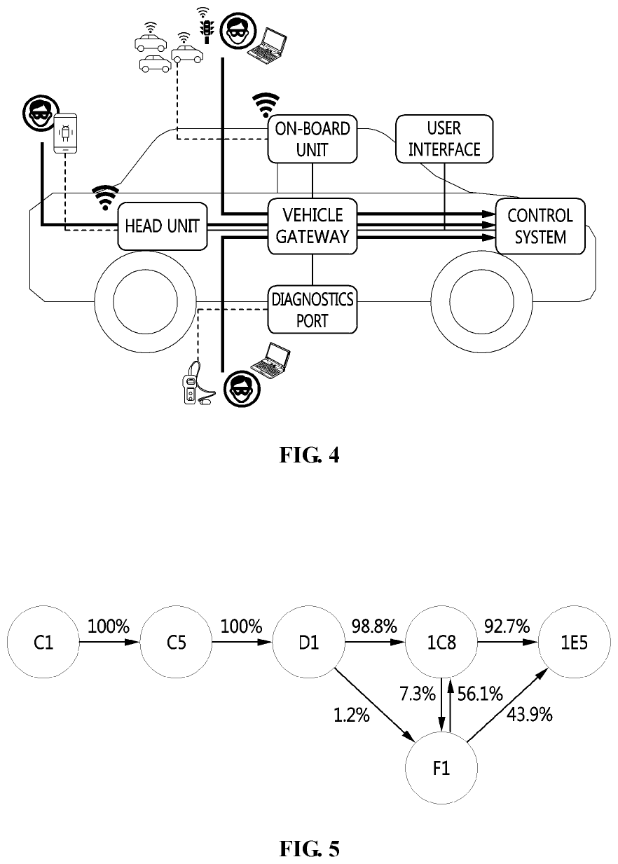

Referring to FIG. 4, an intrusion path of an in-vehicle communication network according to the present invention may include the head unit, the on-board unit, and the diagnostics port.

For example, in the case of the head unit, intrusion into the vehicle may occur via an infected smartphone, notebook or smartphone application connected through a USB port or a Wi-F₁ interface. Further, in the case of the on-board unit, there may occur the case where a forged certificate or a fake message is sent over an external network or where a control command is remotely sent to the inside of the vehicle through telematics hacking, as in the case of Jeep Cherokee. Furthermore, the diagnostics port is the most easily accessible hacking path, through which a CAN packet is monitored through the OBD-II port and is analyzed, whereby a specific control construction may be acquired and injected into the vehicle.

Therefore, the present invention is intended to implement an algorithm enabling the anomaly detection system included in the vehicle gateway to detect anomalies and monitor the CAN bus of the control system.

Here, multiple sub-networks may be generated to correspond to sequence combinations, each having CAN IDs transmitted from multiple vehicle control units connected to the CAN as respective nodes.

Here, each sequence combination may include at least two nodes.

For example, assuming that the CAN of the vehicle is composed of CAN IDs transmitted from vehicle control units corresponding to C1, C5, D1, 1C8, 1E5, and F1, as illustrated in FIG. 5, a list of CAN IDs corresponding to respective vehicle control units may be generated. That is, C1, C5, D1, 1C8, 1E5, and F1 may correspond to respective control network IDs or CAN IDs. Thereafter, respective sequence trees may be generated to correspond to sequence combinations starting with each control network ID or CAN ID. That is, the sequence combination starting with C1 may correspond to (C1, C5), (C1, C5, D1), (C1, C5, D1, 1C8), (C1, C5, D1, F1), (C1, C5, D1, 1C8, 1E5), (C1, C5, D1, 1C8, F1), (C1, C5, D1, F1, 1C8), and (C1, C5, D1, F1, 1E5), and sub-networks may mean networks corresponding to respective sequence combinations.

Here, when sequence trees corresponding to respective multiple sub-networks are generated, traffic proportions for respective nodes included in each sequence tree may be calculated.

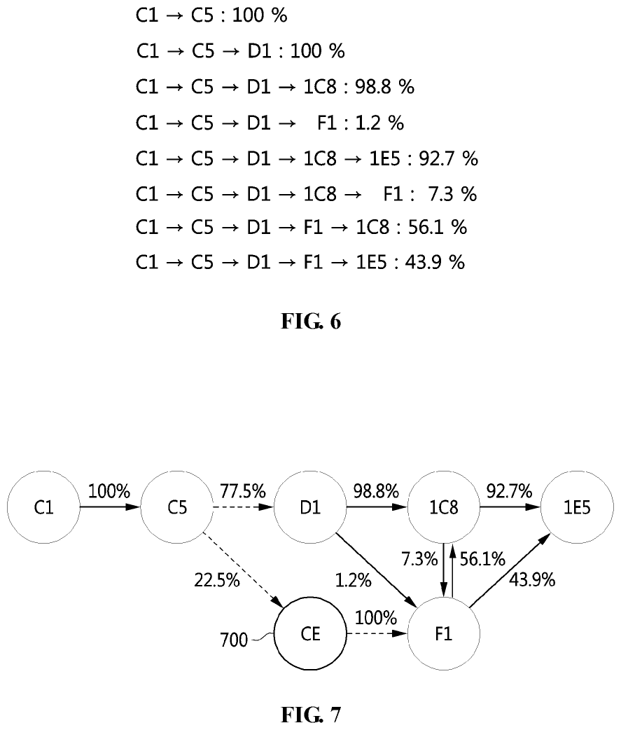

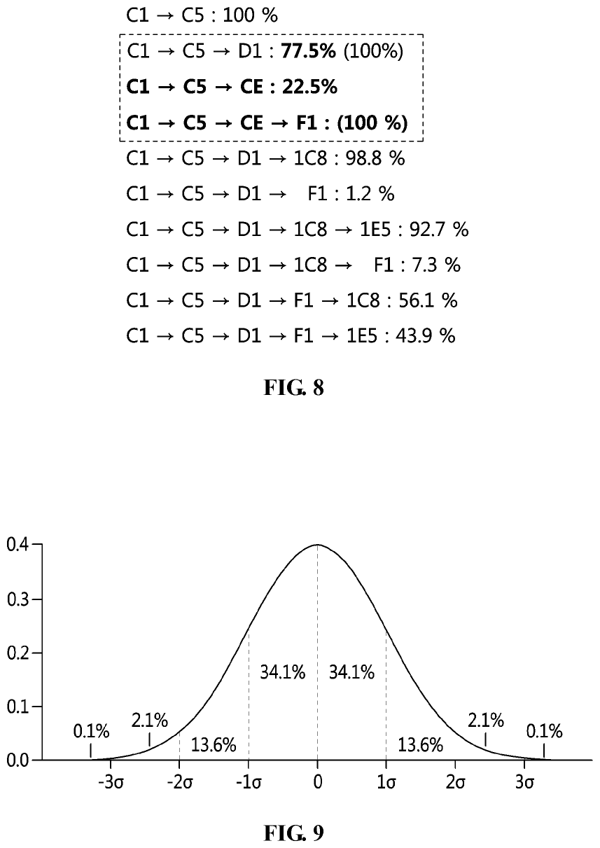

The traffic proportions for respective nodes may mean the percentages of messages delivered between respective nodes, as illustrated in FIG. 5. That is, the proportion of traffic delivered from C1 to C5 is 100% because there is a single path between C1 and C5. However, since the path branches from D1 to 1C8 and F1, the proportion of traffic between D1 and 1C8 and the proportion of traffic between D1 and F1 may be respectively calculated. The traffic proportions calculated in this way may be indicated for respective sequence combinations, that is, sub-networks, as illustrated in FIG. 6.

Also, although not illustrated in FIG. 1, the method for detecting anomalies in the controller area network of the vehicle according to an embodiment of the present invention may repeatedly perform monitoring of the controller area network when the status of the vehicle is normal.

Based on learning using the results of repeatedly performed monitoring, normal sequence trees may be generated.

For the reliability of normal sequence trees, learning may be conducted by performing monitoring of the controller area network in the normal status of the vehicle a preset reference number of times or more.

The normal sequence trees may be stored in a sequence tree database (DB) or sequence tree storage, and may then be subsequently used for a comparison with sequence trees generated via monitoring.

Also, the method for detecting anomalies in the controller area network of the vehicle according to the present invention compares at least one normal sequence tree, which is generated in accordance with the controller area network when the status of the vehicle is normal, with the generated sequence trees at step S120.

Then, the method for detecting anomalies in the controller area network of the vehicle according to the embodiment of the present invention may calculate differences between traffic proportions for respective nodes based on the results of a comparison between the sequence trees, and may detect anomalies in the vehicle in consideration of the differences at step S125.

When at least one of the case where a new node is present in the corresponding sequence tree and a difference between nodes occurs and the case where the differences between traffic proportions for respective nodes are greater than the threshold value is satisfied, it may be determined that an anomaly has occurred in the vehicle.

For example, assuming that the sequence tree illustrated in FIG. 5 is a normal sequence tree and the sequence tree illustrated in FIG. 7 is a sequence tree obtained through monitoring, it can be detected, based on the results of a comparison between the sequence trees, that a new node corresponding to CE has been added to the sequence tree obtained through monitoring and that, with the addition of the CE, traffic proportions for respective nodes have changed. Therefore, in this case, it may be determined that an anomaly has occurred in the vehicle.

Here, checking the traffic proportions for respective nodes may be a technique for extracting feature sets for detecting an anomaly related to intrusion, and may be performed with the intention of securing feature sets by analyzing statistical probability distribution characteristics or the like.

For example, for respective combinations of sequence trees corresponding to respective multiple sub-networks, the number of traffic receptions per unit time (e.g., 1 second or 1 minute), the mean value of traffic proportions, the maximum and minimum values of traffic proportions, and the deviation of traffic proportions are calculated, and the corresponding values are exploited to set a threshold value for anomalies. Here, since the range defined by the upper limit and the lower limit of the threshold value may influence the detection rate of anomalies, such as false positives or false negatives, the present invention may use the maximum value and the minimum value of traffic proportions for respective nodes as the upper limit and the lower limit of the threshold value without change, depending on sensitivity to detection rate. In addition, when the deviation is large and traffic proportions are not sensitive to detection rate, the range of the threshold value may be designated (e.g., a range of mean±3σ) using a mean value and a standard deviation, as illustrated in FIG. 9.

Here, when the range of the threshold value is set using a statistical probability distribution, such as that shown in FIG. 9, the number of false positives or false negatives may be increased when the number of samples is small.

Therefore, the present invention may set the threshold value in consideration of message-sending periods for respective sub-networks corresponding to sequence combinations constituting the sequence trees.

Here, the threshold value may be set using traffic values per unit time and the standard deviation of traffic values in consideration of message-sending periods for respective sub-networks extracted based on the normal sequence trees.

When each message-sending period is shorter than a preset reference period, the maximum value and the minimum value of traffic per unit time may be set as the upper limit and the lower limit of the threshold value, respectively.

For example, in the case of a sequence tree composed only of sequence combinations having a message-sending period of 10 ms, not only a message reception frequency but also reception frequency for the sequence combinations may also be high. Therefore, in the case of this sequence combination, in order to detect a replay attack message, it does not matter if the upper limit and the lower limit of the threshold value are respectively used as the maximum value and the minimum value of traffic proportions per unit time, without change.

When the message-sending period is equal to or longer than the preset reference period, an error range set based on the standard deviation may be set as the range of the threshold value.

For example, in the case of a sequence tree composed only of sequence combinations having a message-sending period of 1000 ms, even if the unit time is set to a long time (e.g., 1 minute), a message reception frequency and a reception frequency for the sequence combinations are inevitably low. Therefore, in this case, the range of the threshold value for sequence combinations may be set to a range wider than the range defined by the maximum value and the minimum value of traffic proportions, and may be designated in accordance with an error range that is set based on a standard deviation, such as that shown in FIG. 9.

Since the present invention detects anomalies in consideration of the differences between traffic proportions for respective nodes as well as the presence or absence of a new node, even an attack using existing sequence combinations (e.g., a replay attack or a DoS attack) may be detected.

Next, when an anomaly is detected as a result of detection at step S125, the method for detecting anomalies in the controller area network of the vehicle according to the embodiment of the present invention provides an alert to the driver or owner of the vehicle through the user interface at step S130.

Further, when no anomaly is detected as a result of the detection at step S125, the method for detecting anomalies in the controller area network of the vehicle according to the embodiment of the present invention may repeatedly detect an anomaly in the controller area network of the vehicle by re-performing a procedure from step S110.

Furthermore, although not illustrated in FIG. 1, the method for detecting anomalies in the controller area network of the vehicle according to the embodiment of the present invention may store various types of information generated during the above-described anomaly detection procedure in a separate storage module.

Meanwhile, the above-described method according to the present invention may be created as a computer program. Further, code and code segments constituting the program may be easily inferred by computer programmers skilled in the art. Furthermore, the created program may be stored in a computer-readable storage medium (information storage medium), and may be read and executed by the computer to implement the method of the present invention. Examples of the storage medium may include all types of computer-readable storage media.

By means of the method for detecting anomalies in the controller area network of the vehicle, anomalies may be detected with respect to the situation in which sequence trees for respective IDs of a CAN bus in a vehicle are changed by a reference value or more based on the results of learning.

Further, the present invention may provide robust detection technology that can also detect repetitive injection of pattern messages recognized as normal messages as well as message patterns newly added to the controller area network of the vehicle.

Furthermore, the present invention may provide an alert, advising of an illegal attempt, to a driver or an owner of a vehicle when hacking of a vehicle is attempted or intrusion into the vehicle is attempted, thus making the driver or owner aware of the danger.

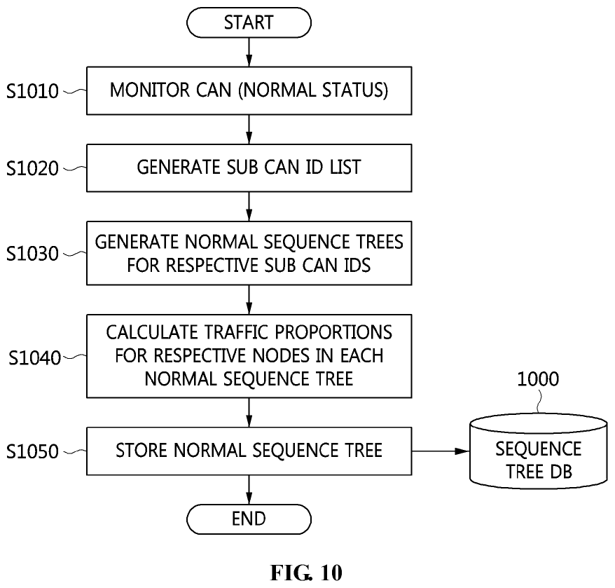

FIG. 10 is an operation flowchart illustrating in detail a process for generating a normal sequence tree in the method for detecting anomalies in a controller area network of a vehicle according to an embodiment of the present invention.

Referring to FIG. 10, in the process for generating a normal sequence tree in the method for detecting anomalies in the controller area network of the vehicle according to the embodiment of the present invention, when the status of a vehicle is normal, the controller area network in the vehicle is monitored at step S1010, and a CAN ID list may be generated in accordance with sequence combinations constituting multiple sub-networks at step S1020.

Thereafter, normal sequence trees for respective CAN IDs may be generated at step S1030, and the proportions of network traffic may be calculated for respective nodes in each normal sequence tree at step S1040.

Thereafter, the generated normal sequence trees may be stored, together with the proportions of network traffic for respective nodes calculated at step S1040, in a sequence tree DB 1000 at step S1050.

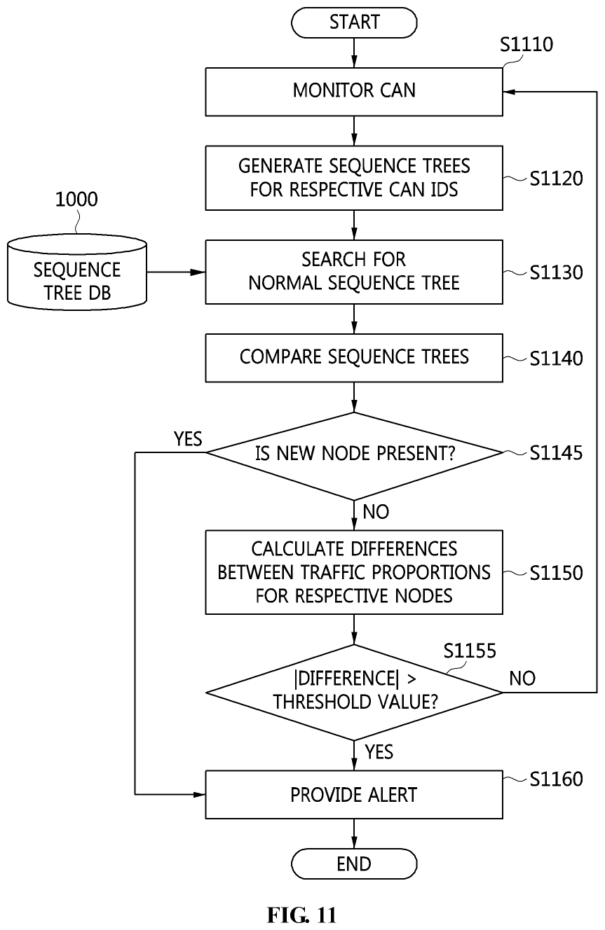

FIG. 11 is an operation flowchart illustrating in detail a process for detecting anomalies in the method for detecting anomalies in a controller area network of a vehicle according to an embodiment of the present invention.

Referring to FIG. 11, in the anomaly detection process in the method for detecting anomalies in the controller area network of the vehicle according to the embodiment of the present invention, the controller area network in the vehicle may be monitored at step S1110, and then sequence trees for multiple sub-networks indicating the current driving status of the vehicle may be generated at step S1120.

Thereafter, a normal sequence tree may be searched for in the sequence tree DB 1000, such as that shown in FIG. 10, at step S1130, and the found normal sequence tree may be compared with the sequence trees generated depending on the currently monitored driving status at step S1140.

That is, the sequence tree corresponding to the case where the vehicle is normally driven may be compared with each sequence tree corresponding to the currently monitored driving status.

Thereafter, whether a new node is present in the sequence tree corresponding to the currently monitored driving status is determined based on the results of the comparison between the sequence trees at step S1145. When it is determined that the new node is present in the sequence tree, an alert may be provided to the driver of the vehicle through a user interface at step S1160.

In contrast, when it is determined at step S1145 that no new node is present, differences between the proportions of traffic for respective nodes may be calculated based on the results of the comparison between the sequence trees at step S1150.

Thereafter, whether the difference between traffic proportions for two sequence nodes is calculated as values greater than a threshold value is determined at step S1155. When the difference between the traffic proportions for the two sequence nodes is greater than the threshold value, an alert may be provided to the driver through the user interface at step S1160.

Also, when it is determined at step S1155 that the difference between the traffic proportions for the two sequence nodes is not greater than the threshold value, the procedure for monitoring the controller area network of the vehicle may be continuously performed at step S1110.

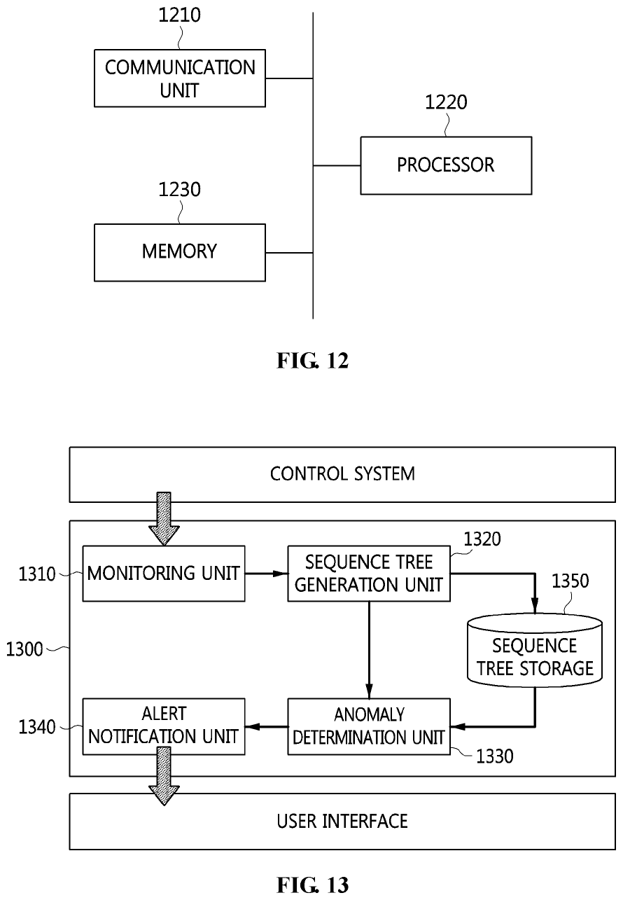

FIG. 12 is a block diagram illustrating an apparatus for detecting anomalies in a controller area network of a vehicle according to an embodiment of the present invention.

Referring to FIG. 12, the apparatus for detecting anomalies in the controller area network of the vehicle according to the embodiment of the present invention may include a communication unit 1210, a processor 1220, and memory 1230.

The communication unit 1210 may function to transmit/receive information required for detection of anomalies in the controller area network of the vehicle over a communication network such as a typical network. In particular, the communication unit 1210 according to the present invention may receive traffic information required in order to calculate traffic proportions from multiple vehicle control units connected to the controller area network of the vehicle. Further, when it is determined that an anomaly has occurred in the vehicle, notification of an alert may be delivered to the driver through a user interface, and then information about the danger to the vehicle may be provided to the driver.

The processor 1220 may monitor the Controller Area Network (CAN) of the vehicle, and may generate sequence trees for respective multiple sub-networks included in the CAN at the time at which monitoring is performed.

First, an in-vehicle communication network architecture according to an embodiment of the present invention may include a head unit, an on-board unit, a vehicle gateway, a diagnostics port, a user interface, and a control system, as illustrated in FIG. 2.

The head unit may correspond to an infotainment device which takes charge of Audio, Video, Navigation (AVN) functions, and may provide a function of interworking with a smart device through Wi-Fi, Bluetooth, or Universal Serial Bus (USB) connection.

The on-board unit performs Wireless Access for Vehicle Environment (WAVE) communication so as to realize inter-vehicle communication and communication between the vehicle and infrastructure. For this, research into services that use Long-Term Evolution (LTE) and fifth-generation (5G) communication through mobile carriers has been conducted.

The diagnostics port may correspond to a port used to connect an exclusive diagnosis device so as to check the status of the vehicle including the occurrence of faults or failure in the vehicle, and may be an On-Board Diagnostics (OBD-II) port.

The control system may be implemented such that various ECUs in the vehicle are grouped into a single unit, and may be composed of various sub-networks using a Controller Area Network (CAN), a CAN with Flexible Data rate (CAN-FD), a Local Interconnect Network (LIN), FlexRay, Media Oriented Systems Transport (MOST), Automotive Ethernet, or the like.

The vehicle gateway may manage information of various sub-networks in the control system, and may take charge of information delivery between various devices, such as the on-board unit and the head unit.

Also, the vehicle gateway may be a device including an apparatus for detecting anomalies in a controller area network of a vehicle according to an embodiment of the present invention, and may provide alert guidance through the user interface when the apparatus for detecting anomalies in the controller area network of the vehicle detects an anomaly or intrusion into the vehicle.

Below, the relationship between the vehicle gateway and the control system will be described in detail with reference to FIG. 3.

First, as illustrated in FIG. 3, the vehicle gateway may manage information of various sub-networks of the control system, and may include an anomaly detection system considered important in the present invention while performing its original function of performing information delivery between various devices, such as the on-board unit and the head unit. Also, the control system may be implemented by grouping 50 to 100 various ECUs, such as a brake control ECU, a transmission control ECU, an engine management ECU, a suspension ECU, a door control ECU, a seat control ECU, and a power windows ECU, per vehicle into a single system.

Referring to FIG. 4, an intrusion path of an in-vehicle communication network according to the present invention may include the head unit, the on-board unit, and the diagnostics port.

For example, in the case of the head unit, intrusion into the vehicle may occur via an infected smartphone, notebook or smartphone application connected through a USB port or a Wi-Fi interface. Further, in the case of the on-board unit, there may occur the case where a forged certificate or a fake message is sent over an external network or where a control command is remotely sent to the inside of the vehicle through telematics hacking, as in the case of Jeep Cherokee. Furthermore, the diagnostics port is the most easily accessible hacking path, through which a CAN packet is monitored through the OBD-II port and is analyzed, whereby a specific control construction may be acquired and injected into the vehicle.

Therefore, the present invention is intended to implement an algorithm enabling the anomaly detection system included in the vehicle gateway to detect anomalies and monitor the CAN bus of the control system.

Here, multiple sub-networks may be generated to correspond to sequence combinations, each having CAN IDs transmitted from multiple vehicle control units connected to the CAN as respective nodes.

Here, each sequence combination may include at least two nodes.

For example, assuming that the CAN of the vehicle is composed of CAN IDs transmitted from vehicle control units corresponding to C1, C5, D1, 1C8, 1E5, and F1, as illustrated in FIG. 5, a list of CAN IDs corresponding to respective vehicle control units may be generated. That is, C1, C5, D1, 1C8, 1E5, and F1 may correspond to respective control network IDs or CAN IDs. Thereafter, respective sequence trees may be generated to correspond to sequence combinations starting with each control network ID or CAN ID. That is, the sequence combination starting with C1 may correspond to (C1, C5), (C1, C5, D1), (C1, C5, D1, 1C8), (C1, C5, D1, F1), (C1, C5, D1, 1C8, 1E5), (C1, C5, D1, 1C8, F1), (C1, C5, D1, F1, 1C8), and (C1, C5, D1, F1, 1E5), and sub-networks may mean networks corresponding to respective sequence combinations.

Here, when sequence trees corresponding to respective multiple sub-networks are generated, traffic proportions for respective nodes included in each sequence tree may be calculated.

The traffic proportions for respective nodes may mean the percentages of messages delivered between respective nodes, as illustrated in FIG. 5. That is, the proportion of traffic delivered from C1 to C5 is 100% because there is a single path between C1 and C5. However, since the path branches from D1 to 1C8 and F1, the proportion of traffic between D1 and 1C8 and the proportion of traffic between D1 and F1 may be respectively calculated. The traffic proportions calculated in this way may be indicated for respective sequence combinations, that is, sub-networks, as illustrated in FIG. 6.

Also, the processor 1220 may repeatedly perform monitoring of the controller area network when the status of the vehicle is normal.

Based on learning using the results of repeatedly performed monitoring, normal sequence trees may be generated.

For the reliability of normal sequence trees, learning may be conducted by performing monitoring of the controller area network in the normal status of the vehicle a preset reference number of times or more.

The normal sequence trees may be stored in a sequence tree database (DB) or sequence tree storage, and may then be subsequently used for a comparison with sequence trees generated via monitoring.

Further, the processor 1220 compares at least one normal sequence tree, which is generated in accordance with the controller area network when the status of the vehicle is normal, with the generated sequence trees.

Furthermore, the processor 1220 may calculate differences between traffic proportions for respective nodes based on the results of a comparison between the sequence trees, and may detect anomalies in the vehicle in consideration of the differences.

When at least one of the case where a new node is present in the corresponding sequence tree and a difference between nodes occurs and the case where the differences between traffic proportions for respective nodes are greater than the threshold value is satisfied, it may be determined that an anomaly has occurred in the vehicle.

For example, assuming that the sequence tree illustrated in FIG. 5 is a normal sequence tree and the sequence tree illustrated in FIG. 7 is a sequence tree obtained through monitoring, it can be detected, based on the results of a comparison between the sequence trees, that a new node corresponding to CE has been added to the sequence tree obtained through monitoring and that, with the addition of the CE, traffic proportions for respective nodes have changed. Therefore, in this case, it may be determined that an anomaly has occurred in the vehicle.

Here, checking the traffic proportions for respective nodes may be a technique for extracting feature sets for detecting an anomaly related to intrusion, and may be performed with the intention of securing feature sets by analyzing statistical probability distribution characteristics or the like.

For example, for respective combinations of sequence trees corresponding to respective multiple sub-networks, the number of traffic receptions per unit time (e.g., 1 second or 1 minute), the mean value of traffic proportions, the maximum and minimum values of traffic proportions, and the deviation of traffic proportions are calculated, and the corresponding values are exploited to set a threshold value for anomalies. Here, since the range defined by the upper limit and the lower limit of the threshold value may influence the detection rate of anomalies, such as false positives or false negatives, the present invention may use the maximum value and the minimum value of traffic proportions for respective nodes as the upper limit and the lower limit of the threshold value without change, depending on sensitivity to detection rate. In addition, when the deviation is large and traffic proportions are not sensitive to detection rate, the range of the threshold value may be designated (e.g., a range of mean±3σ) using a mean value and a standard deviation, as illustrated in FIG. 9.

Here, when the range of the threshold value is set using a statistical probability distribution, such as that shown in FIG. 9, the number of false positives or false negatives may be increased when the number of samples is small.

Therefore, the present invention may set the threshold value in consideration of message-sending periods for respective sub-networks corresponding to sequence combinations constituting the sequence trees.

Here, the threshold value may be set using traffic values per unit time and the standard deviation of traffic values in consideration of message-sending periods for respective sub-networks extracted based on the normal sequence trees.

When each message-sending period is shorter than a preset reference period, the maximum value and the minimum value of traffic per unit time may be set as the upper limit and the lower limit of the threshold value, respectively.

For example, in the case of a sequence tree composed only of sequence combinations having a message-sending period of 10 ms, not only a message reception frequency but also reception frequency for the sequence combinations may also be high. Therefore, in the case of this sequence combination, in order to detect a replay attack message, it does not matter if the upper limit and the lower limit of the threshold value are respectively used as the maximum value and the minimum value of traffic proportions per unit time, without change.

When the message-sending period is equal to or longer than the preset reference period, an error range set based on the standard deviation may be set as the range of the threshold value.

For example, in the case of a sequence tree composed only of sequence combinations having a message-sending period of 1000 ms, even if the unit time is set to a long time (e.g., 1 minute), a message reception frequency and a reception frequency for the sequence combinations are inevitably low. Therefore, in this case, the range of the threshold value for sequence combinations may be set to a range wider than the range defined by the maximum value and the minimum value of traffic proportions, and may be designated in accordance with an error range that is set based on a standard deviation, such as that shown in FIG. 9.

Since the present invention detects anomalies in consideration of the differences between traffic proportions for respective nodes as well as the presence or absence of a new node, even an attack using existing sequence combinations (e.g., a replay attack or a DoS attack) may be detected.

When an anomaly is detected, the processor 1220 may provide an alert the driver or owner of the vehicle through the user interface.

When no anomaly is detected, the processor 1220 may repeatedly detect an anomaly in the controller area network of the vehicle by re-performing monitoring.

The memory 1230 may store at least one normal sequence tree.

Further, as described above, the memory 1230 may store various types of information generated in the apparatus for detecting anomalies in the controller area network of the vehicle according to the embodiment of the present invention.

In an embodiment, the memory 1230 may be configured independently of the apparatus for detecting anomalies in the controller area network of the vehicle, and may support a function of detecting anomalies in the controller area network of the vehicle. In this case, the memory 1230 may be operated as separate large-capacity storage, and may also include a control function for performing operations.

Meanwhile, the apparatus for detecting anomalies in the controller area network of the vehicle may be equipped with memory, and may internally store information in the apparatus. In an embodiment, the memory may be a computer-readable storage medium. In an embodiment, the memory may be a volatile memory unit, and in another embodiment, the memory may be a nonvolatile memory unit. In an embodiment, a storage device may be a computer-readable storage medium. In various different embodiments, the storage device may include, for example, a hard disk device, an optical disk device or any other mass storage device.

By means of the apparatus for detecting anomalies in the controller area network of the vehicle, anomalies may be detected with respect to the situation in which sequence trees for respective IDs of a CAN bus in a vehicle are changed by a reference value or more based on the results of learning.

Further, the present invention may provide robust detection technology that can also detect repetitive injection of pattern messages recognized as normal messages as well as message patterns newly added to the controller area network of the vehicle.

Furthermore, the present invention may provide an alert, advising of an illegal attempt, to a driver or an owner of a vehicle when hacking of a vehicle is attempted or intrusion into the vehicle is attempted, thus making the driver or owner aware of the danger.

FIG. 13 is a block diagram illustrating a system for detecting anomalies in a controller area network of a vehicle, which is included in the vehicle gateway of FIG. 2.

Referring to FIG. 13, the vehicle gateway 1300 illustrated in FIG. 2 may include a monitoring unit 1310 for monitoring the controller area network of a control system in order to detect anomalies in the controller area network of the vehicle based on sequence trees, a sequence tree generation unit 1320 for generating sequence trees for respective CAN IDs of the vehicle, and an anomaly determination unit 1330 for comparing the sequence trees for respective CAN IDs generated through a learning procedure with sequence trees generated to detect anomalies during driving, and then determining whether an anomaly has occurred, an alert notification unit 1340 for providing an alert through a user interface when an anomaly or intrusion is detected, and sequence tree storage 1350 for storing the generated sequence trees and traffic proportions for respective nodes.

That is, the vehicle gateway 1300 according to the embodiment of the present invention may include individual sub-blocks for detecting anomalies in the vehicle.

For example, the CAN bus of the control system is monitored through the monitoring unit 1310, and the sequence tree generation unit 1320 may generate sequence trees for respective CAN IDs, and may then calculate traffic proportions for respective nodes with respect to normal driving status. Here, the generated sequence trees may be stored in the sequence tree storage 1350. Thereafter, when intrusion occurs during the driving of the vehicle, the anomaly determination unit 1330 may determine whether an anomaly or intrusion has occurred, in consideration of the presence or absence of a new node or traffic proportions for respective nodes based on the sequence trees stored in the sequence tree storage 1350. If it is determined by the anomaly determination unit 1330 that an anomaly or intrusion into the vehicle has occurred, alert guidance is provided through the user interface in the vehicle by the alert notification unit 1340, thus making the driver aware of the danger.

In accordance with the present invention, anomalies may be detected with respect to the situation in which sequence trees for respective IDs of a CAN bus in a vehicle are changed by a reference value or more based on the results of learning.

Further, the present invention may provide robust detection technology that can also detect repetitive injection of pattern messages recognized as normal messages as well as message patterns newly added to the controller area network of the vehicle.

Furthermore, the present invention may provide an alert, advising of an illegal attempt, to a driver or an owner of a vehicle when hacking of a vehicle is attempted or intrusion into the vehicle is attempted, thus making the driver or owner aware of the danger.

As described above, in the method detecting anomalies in a Controller Area Network (CAN) of a vehicle and the apparatus for the method according to the present invention, the configurations and schemes in the above-described embodiments are not limitedly applied, and some or all of the above embodiments can be selectively combined and configured so that various modifications are possible.

What is claimed is:

1. A method for detecting anomalies in a Controller Area Network (CAN) of a vehicle, comprising:
monitoring the controller area network of the vehicle and generating sequence trees for respective multiple sub-networks included in the controller area network at a time at which monitoring is performed;
comparing at least one normal sequence tree, generated in accordance with the controller area network when a status of the vehicle is normal, with the generated sequence trees; and
calculating differences between traffic proportions for respective nodes based on a result of the comparison between the sequence trees, and detecting an anomaly in the vehicle in consideration of the differences.

2. The method of claim 1, wherein detecting the anomaly is configured to, when at least one of a case where a new node is present in a corresponding sequence tree and then a difference between respective nodes occurs and a case where the differences between the traffic proportions for respective nodes are greater than a threshold value is satisfied, determine that the anomaly has occurred in the vehicle.

3. The method of claim 1, wherein the multiple sub-networks are generated to correspond to sequence combinations, each having CAN IDs transmitted from multiple vehicle control units connected to the controller area network as respective nodes.

4. The method of claim 3, wherein each of the sequence combinations comprises at least two nodes.

5. The method of claim 1, further comprising:
repeatedly performing monitoring of the controller area network when the status of the vehicle is normal; and
generating the normal sequence tree based on learning using a result of the repeatedly performed monitoring.

6. The method of claim 2, wherein the threshold value is set using traffic values per unit time and a standard deviation of traffic values in consideration of message-sending periods for respective sub-networks extracted based on the normal sequence tree.

7. The method of claim 6, wherein the threshold value is set such that, when each message-sending period is shorter than a preset reference period, a maximum value and a minimum value of traffic per unit time are set as an upper limit and a lower limit of the threshold value, respectively.

8. The method of claim 6, wherein the threshold value is set such that, when each message-sending period is equal to or longer than the preset reference period, an error range that is designated based on the standard deviation is set as a range of the threshold value.

9. An apparatus for detecting anomalies in a Controller Area Network (CAN) of a vehicle, comprising:
a processor for monitoring the controller area network of the vehicle, generating sequence trees for respective multiple sub-networks included in the controller area network at a time at which monitoring is performed, comparing at least one normal sequence tree, generated in accordance with the controller area network when a status of the vehicle is normal, with the generated sequence trees, calculating differences between traffic proportions for respective nodes based on a result of the comparison between the sequence trees, and detecting an anomaly in the vehicle in consideration of the differences; and
a memory for storing the at least one normal sequence tree.

10. The apparatus of claim 9, wherein the processor is configured to, when at least one of a case where a new node is present in a corresponding sequence tree and then a difference between respective nodes occurs and a case where the differences between the traffic proportions for respective nodes are greater than a threshold value is satisfied, determine that the anomaly has occurred in the vehicle.

11. The apparatus of claim 9, wherein the multiple sub-networks are generated to correspond to sequence combinations, each having CAN IDs transmitted from multiple vehicle control units connected to the controller area network as respective nodes.

12. The apparatus of claim 11, wherein each of the sequence combinations comprises at least two nodes.

13. The apparatus of claim 9, wherein the processor is configured to repeatedly perform monitoring of the controller area network when the status of the vehicle is normal and generates the normal sequence tree based on learning using a result of the repeatedly performed monitoring.

14. The apparatus of claim 10, wherein the threshold value is set using traffic values per unit time and a standard deviation of traffic values in consideration of message-sending periods for respective sub-networks extracted based on the normal sequence tree.

15. The apparatus of claim 14, wherein the threshold value is set such that, when each message-sending period is shorter than a preset reference period, a maximum value and a minimum value of traffic per unit time are set as an upper limit and a lower limit of the threshold value, respectively.

16. The apparatus of claim 14, wherein the threshold value is set such that, when each message-sending period is equal to or longer than the preset reference period, an error range that is designated based on the standard deviation is set as a range of the threshold value.
